(19) United States
(12) Patent Application Publication
(10) Pub. No.: US 2025/0284135 A1
(43) Pub. Date: Sep. 11, 2025

(54) Four-Way Image Splitter for High-Speed Characterization of Tissue Samples

(71) Applicant: The Trustees of Columbia University in the City of New York, New York, NY (US)

(72) Inventors: Elizabeth M.C. HILLMAN, New York, NY (US); Malte CASPER, New York, NY (US); Citlali Perez CAMPOS, Saratoga Springs, NY (US)

(73) Assignee: The Trustees of Columbia University in the City of New York, New York, NY (US)

(21) Appl. No.: 19/219,305

(22) Filed: May 27, 2025

Related U.S. Application Data
(63) Continuation of application No. PCT/US2023/081774, filed on Nov. 30, 2023.
(60) Provisional application No. 63/428,800, filed on Nov. 30, 2022.

(51) Int. Cl. G02B 27/14; H04N 23/55; H04N 23/90

(52) U.S. Cl. CPC G02B 27/141; H04N 23/55; H04N 23/90

(57) ABSTRACT

A four-way image splitter includes first, second, and third dichroic beam splitters, and a set of steering mirrors. The first dichroic beam splitter accepts an incoming beam that includes four wavelengths of light λ1-λ4, routes wavelengths λ1 and λ2 onto a first optical path, and routes wavelengths λ3 and λ4 onto a second optical path. The second dichroic beam accepts light that arrives via the second optical path, routes wavelength λ3 onto a third optical path, and routes wavelength λ4 onto a fourth optical path. The third dichroic beam splitter accepts light that arrives via the first optical path, routes wavelength λ1 onto a fifth optical path, and routes wavelength λ2 onto a sixth optical path. And the steering mirrors redirect the third, fourth, fifth, and sixth optical paths towards a camera chip.

### CROSS REFERENCE TO RELATED APPLICATIONS

This Application is a continuation of International Application PCT/US2023/081774, filed Nov. 30, 2023, which claims the benefit of U.S. Provisional Application 63/428,800 filed Nov. 30, 2022, each of which is incorporated herein by reference in its entirety.

### STATEMENT REGARDING FEDERALLY-SPONSORED RESEARCH

This invention was made with government support under MH128969 awarded by the National Institutes of Health. The government has certain rights in the invention.

### BACKGROUND

The conventional approach for characterizing different types of cells within a tissue sample (e.g., cleared and immunostained human brain) is to use an individual fluorophore for each different type of cell that you are looking for. After staining, if a cell expresses a given target for a label, it will be counted as positive for that label. However, this approach means that you can only characterize the same number of cell types as you have colors of fluorophores. For example, using three different fluorophores means that you can only identify three different types of cells in the sample. Alas, the number of fluorophores that can be used in a tissue sample an any given time is not unlimited due to spectral overlap, filter and laser availability, and the fact that most immunohistochemistry methods require primary and secondary antibodies to use specific pairs of species, of which there are relatively few that don't interfere. The practical limit is typically three or at most four fluorophores in a sample at any given time.

The conventional approach for characterizing more than three or four types of cells within a tissue sample is to begin with a first set of three or four fluorophores, and use those fluorophores to detect the presence of three or four cell types. The sample is then stripped and re-stained with three or four different fluorophores, after which the presence of three or four different cell types can be detected. But this is a complex and slow process that can be computationally difficult for large samples (which typically deform and/or change between imaging rounds).

### SUMMARY OF THE INVENTION

One aspect of this application is directed to a first image splitter that comprises a first dichroic beam splitter, a second dichroic beam splitter, a third dichroic beam splitter, and at least one steering mirror. The first dichroic beam splitter is positioned to accept an incoming beam that includes four wavelengths of light λ1, λ2, λ3, and λ4, route wavelengths λ1 and λ2 onto a first optical path, and route wavelengths λ3 and λ4 onto a second optical path. The second dichroic beam splitter is positioned to accept light that arrives via the second optical path, route wavelength λ3 onto a third optical path, and route wavelength λ4 onto a fourth optical path. The third dichroic beam splitter is positioned to accept light that arrives via the first optical path, route wavelength λ1 onto a fifth optical path, and route wavelength λ2 onto a sixth optical path. And the at least one steering mirror is positioned to redirect at least one of the third optical path, the fourth optical path, the fifth optical path, and the sixth optical path towards a camera chip.

In some embodiments of the first image splitter, λ2 is longer than λ1, λ3 is longer than λ2, and λ4 is longer than λ3. In some embodiments of the first image splitter, the first dichroic beam splitter reflects wavelengths λ1 and λ2 onto the first optical path, and transmits wavelengths λ3 and λ4 onto the second optical path.

In some embodiments of the first image splitter, the at least one steering mirror is positioned to redirect the third optical path, the fourth optical path, the fifth optical path, and the sixth optical path towards respective different regions of a single camera chip. In some embodiments of the first image splitter, the at least one steering mirror is positioned to redirect at least three of the third optical path, the fourth optical path, the fifth optical path, and the sixth optical path towards respective different regions of a single camera chip.

In some embodiments of the first image splitter, the at least one steering mirror comprises a first steering mirror positioned to redirect the fifth optical path towards a first region of the camera chip, a second steering mirror positioned to redirect the sixth optical path towards a second region of the camera chip, a third steering mirror positioned to redirect the third optical path towards a third region of the camera chip, and a fourth steering mirror positioned to redirect the fourth optical path towards a fourth region of the camera chip.

Optionally, the embodiments described in the previous paragraph may further comprise the camera chip and a lens positioned between (a) the camera chip and (b) the first, second, third, and fourth steering mirrors. The lens is configured to focus light that arrives from the first, second, third, and fourth steering mirrors onto the camera chip. And the first region of the camera chip, the second region of the camera chip, the third region of the camera chip, and the fourth region of the camera chip are respective different regions of a single camera chip.

Optionally, in the embodiments described in the previous paragraph, a center of the fifth optical path passes through an optical center of the lens, a center of the sixth optical path passes through the optical center of the lens, a center of the third optical path passes through the optical center of the lens, and a center of the fifth optical path passes through the optical center of the lens.

Some embodiments of the first image splitter further comprise a first corner mirror. In these embodiments, the first optical path proceeds in a Z direction from the first dichroic beam splitter to the first corner mirror, and subsequently proceeds in an X direction from the first corner mirror to the third dichroic beam splitter. The second optical path proceeds in the X direction from the first dichroic beam splitter to the second dichroic beam splitter. And the X direction and the Z direction are perpendicular.

Optionally, the embodiments described in the previous paragraph may further comprise a second corner mirror and a third corner mirror. In these embodiments, the at least one steering mirror comprises a first steering mirror positioned to redirect the fifth optical path towards a first region of the camera chip, a second steering mirror positioned to redirect the sixth optical path towards a second region of the camera chip, a third steering mirror positioned to redirect the third optical path towards a third region of the camera chip, and a fourth steering mirror positioned to redirect the fourth optical path towards a fourth region of the camera chip. In addition, in these embodiments, (a) the third optical path proceeds in a Y direction from the second dichroic beam splitter to the second corner mirror, and subsequently proceeds in the X direction from the second corner mirror to the third steering mirror, (b) the fourth optical path proceeds in the X direction from the second dichroic beam splitter to the fourth steering mirror, (c) the fifth optical path proceeds in the Y direction from the third dichroic beam splitter to the third corner mirror, and subsequently proceeds in the X direction from the third corner mirror to the first steering mirror, and (d) the sixth optical path proceeds in the X direction from the third dichroic beam splitter to the second steering mirror. The X direction, the Y direction, and the Z direction are mutually perpendicular.

Optionally, the embodiments described in the previous paragraph may further comprise the camera chip and a lens positioned between (a) the camera chip and (b) the first, second, third, and fourth steering mirrors. The lens is configured to focus light that arrives from the first, second, third, and fourth steering mirrors onto the camera chip. In these embodiments, the first region of the camera chip, the second region of the camera chip, the third region of the camera chip, and the fourth region of the camera chip are respective different regions of a single camera chip. The first region of the camera chip is offset in the Z direction with respect to the third region of the camera chip, and the second region of the camera chip is offset in the Z direction with respect to the fourth region of the camera chip.

Optionally, in the embodiments described in the previous paragraph, a center of the fifth optical path passes through an optical center of the lens, a center of the sixth optical path passes through the optical center of the lens, a center of the third optical path passes through the optical center of the lens, and a center of the fifth optical path passes through the optical center of the lens.

Some embodiments of the first image splitter further comprise a first corner mirror and a second corner mirror. In these embodiments, the at least one steering mirror comprises a first steering mirror positioned to redirect the fifth optical path towards a first region of the camera chip, a second steering mirror positioned to redirect the sixth optical path towards a second region of the camera chip, a third steering mirror positioned to redirect the third optical path towards a third region of the camera chip, and a fourth steering mirror positioned to redirect the fourth optical path towards a fourth region of the camera chip. In addition, in these embodiments, (a) the third optical path proceeds in a Y direction from the second dichroic beam splitter to the first corner mirror, and subsequently proceeds in an X direction from the first corner mirror to the third steering mirror, (b) the fourth optical path proceeds in the X direction from the second dichroic beam splitter to the fourth steering mirror, (c) the fifth optical path proceeds in the X direction from the third dichroic beam splitter to the first steering mirror, and (d) the sixth optical path proceeds in the Y direction from the third dichroic beam splitter to the second corner mirror, and subsequently proceeds in the X direction from the second corner mirror to the second steering mirror. The X direction and the Y direction are perpendicular.

Optionally, the embodiments described in the previous paragraph may further comprise the camera chip and a lens positioned between (a) the camera chip and (b) the first, second, third, and fourth steering mirrors. The lens is configured to focus light that arrives from the first, second, third, and fourth steering mirrors onto the camera chip. In these embodiments, the first region of the camera chip, the second region of the camera chip, the third region of the camera chip, and the fourth region of the camera chip are respective different regions of a single camera chip. And the first, second, third, and fourth regions of the single camera chip are all arranged side by side on the single camera chip.

Optionally, in the embodiments described in the previous paragraph, the first, second, third, and fourth regions of the single camera chip each occupy respective different sets of columns within a given set of rows of the single camera chip. Optionally, in the embodiments described in the previous paragraph, a center of the fifth optical path passes through an optical center of the lens, a center of the sixth optical path passes through the optical center of the lens, a center of the third optical path passes through the optical center of the lens, and a center of the fifth optical path passes through the optical center of the lens.

Another aspect of this application is directed to a first method of splitting an incoming beam that includes four wavelengths of light λ1, λ2, λ3, and λ4. The first method comprises routing wavelengths λ1 and λ2 from the incoming beam onto a first optical path, and routing wavelengths λ3 and λ4 from the incoming beam onto a second optical path; routing wavelength λ3 from the second optical path onto a third optical path, and routing wavelength λ4 from the second optical path onto a fourth optical path; routing wavelength λ1 from the first optical path onto a fifth optical path, and routing wavelength λ2 from the first optical path onto a sixth optical path; and redirecting the third optical path, the fourth optical path, the fifth optical path, and the sixth optical path towards respective different regions of a single camera chip.

In some instances of the first method, λ2 is longer than λ1, λ3 is longer than λ2, and λ4 is longer than λ3. In some instances of the first method, the respective different regions of the single camera chip are arranged in a 2×2 configuration. In some instances of the first method, the respective different regions of the single camera chip are arranged in a 1×4 configuration.

### BRIEF DESCRIPTION OF THE DRAWINGS

FIGS. 1, 2, and 3 are side, top-down, and mixed-perspective views, respectively, of one embodiment of a four-way image splitter.

FIG. 4 depicts another embodiment of a four-way image splitter.

FIG. 5 depicts how the camera chip in the FIG. 4 embodiment is oriented.

FIG. 6 depicts how multiple copies of the FIGS. 1-3 or FIG. 4 embodiments can be combined into a single system.

Various embodiments are described in detail below with reference to the accompanying drawings, wherein like reference numerals represent like elements.

### DESCRIPTION OF THE PREFERRED EMBODIMENTS

### Section 1: Fluorophore Coding

Instead of the “one cell type, one fluorophore” approach described above, a “combinatorial coding” approach may be used. This approach assumes it is possible to select non-specific antibodies that would each target a multitude of different cell types. In this case, a cell could have different levels of multiple fluorescent markers, and this combination of levels across different fluorophores can provide a unique “proteomic signature” for each cell. With 2 levels (0 or 1) and 4 fluorophores, this can yield 2\hat{ }4=16 different cell types.

Table 1 below is an example of the conventional approach of using four fluorophores to detect the presence of four different cell types in a given sample.

TABLE 1

| | channel 1: | channel 2: | channel 3: | channel 4: |
|---|---|---|---|---|
| | 561 nm | 594 nm | 660 nm | 780 nm |
| | all neuron | PV | glia label | microglia |
| | label | interneurons | | label |
| exc Neurons | 1 | 0 | 0 | 0 |
| PV interneurons | 1 | 1 | 0 | 0 |
| glia | 0 | 0 | 1 | 0 |
| microglia | 0 | 0 | 0 | 1 |

Now let us examine what happens when we combine multiple different primary antibodies into the same color channel. For example, if the antibodies are designed so that (a) the 561 nm channel will “see” all types of neurons; (b) the 561 nm channel will “see” interneurons & oligodendrocytes; (c) the 561 nm channel will “see” glia & PV interneurons; and (d) the 561 nm channel will “see” microglia, nNOS, & endothelial cells, Table 2 below shows how only four fluorophores can be used to detect the presence of *nine* different types of cells using a coding strategy.

TABLE 2

| | | | | channel 4: | |
|---|---|---|---|---|---|
| | | channel 2: | channel 3: | 780 nm | |
| | | 594 nm | 660 nm | microglia, | |
| | channel 1: | all interneurons | all glia & | nNOS, & | |
| | 561 nm | & oligo- | PV | endothelial | |
| | all neurons | dendrocytes | interneuron | cells | code |
| exc Neurons | 1 | 0 | 0 | 0 | 1000 |
| inh neurons | 1 | 1 | 0 | 0 | 1100 |
| PV inh neurons | 1 | 1 | 1 | 0 | 1110 |
| nNOS | 1 | 1 | 0 | 1 | 1101 |
| interneurons | | | | | |
| nNOS exc | 1 | 0 | 0 | 1 | 1001 |
| neurons | | | | | |
| regular astrocytes | 0 | 0 | 1 | 0 | 0010 |
| microglia | 0 | 0 | 1 | 1 | 0011 |
| oligodendrocytes | 0 | 1 | 1 | 0 | 0110 |
| endothelial cells | 0 | 0 | 0 | 1 | 0001 |

With this coding strategy, when a response is observed in the 561 nm channel, but not in any of the other channels, the code will be 1000, which means that the cell at the corresponding location is an exc neuron (see the first row of table 2). When a response is observed in the 561 and 594 nm channels only, the code will be 1100, which means that the cell at the corresponding location is an inh neuron (see the second row of table 2). Corresponding codes on rows 3-9 indicate that the cell at the corresponding location is the respective cell type.

This approach, in which the number of cell types that can be detected exceeds the number of fluorophores permits a more careful design of the affinity of each label to each cell type (making it easier to ensure good logic in the coding). Although it requires a higher number of primary antibodies, it does not require additional secondary antibodies or spectral imaging channels.

Note that Table 2 is a conceptual example, and it does not list the specific antibodies with the affinities indicated. Nevertheless, the discussion above demonstrates that even with a binary precision of 1 (e.g., the label is either there, or not there) we can encode more than twice as many cell types as the number of color channels. This coding scheme can grow much richer with 8 color channels rather than 4, and can extend further if certain cell sub-types have repeatable but differing levels of expression of proteins, which could thus (for example) encode regular from reactive astrocytes. There is also room in the color space to include other markers such as tau, or markers of inflammation or oxidative stress, which can provide measures of both pathological state and cell type.

When four fluorophores are used together with binary coding (which detects the presence or absence of each fluorophore), the maximum number of different categories of cells that can be detected will be 16 (i.e., 2\hat{ }4). But the coding approach described above can be extended to higher bases. For example, if three levels of each fluorophore (e.g., zero, a low level, and a high level) can be detected, ternary coding can be used to detect up to a maximum of 81 different categories (i.e., 3\hat{ }4). Further still, if the number of fluorophores can be increased to 5 or more, the number of categories can increase by a corresponding amount (e.g., 3\hat{ }5=243 different cell types). Note, however, that this ternary approach relies on finding antibodies that can elegantly target different combinations of cell types, and whose intensity levels are sufficiently quantitative to provide the level of coding described above.

The approaches described in this section can unlock the ability to get the equivalent of highly multiplexed imaging of different cell types without needing excessive numbers of color channels, and better yet to not require stripping and re-staining of samples, which is time-consuming and computationally challenging to accurately overlay cellular expression patterns from one staining round to the next.

The selection of antibodies and combinations can be approached in a rational way. Databases are now available that include single-cell transcriptomic analysis that enables large numbers of different types of cells to be resolved. However, this data is also linked to gene expression data and thus one can determine the protein expression of each of the cell types. While most studies using this kind of transcriptomic data seek to cluster the signatures of each cell and demonstrate that there are a large number of different types of cells, less work has been done to see whether it is possible to describe this rich range of different cells in a simpler way as a selection of overlapping combinations of gene expression. Performing dimensionality reduction on data of this kind to determine an optimal set of different proteins to target, whose different levels of expression in different cell types can provide a lower dimensional way to describe and differentiate the widest number of different cell types. This framework can be used to derive optimal combinations of antibodies (or labels) relating to the strategy above. This model can also be used to evaluate the amount of coverage of different cell types we can expect to achieve for a given design of combinations of antibodies and labels.

### Section 2: Image Splitter Designs

The approach described above in Section 1 enables numerous types of cells to be encoded with a reduced number of spectral channels. However, even imaging four colors of fluorophore can be challenging for some microscopes. Sequentially turning on different lasers, or physically switching filters in-front of a camera or detector reduces the speed of imaging and can lead to the need to register different channels if the sample is changing or moves over time.

To overcome this shortcoming, this section describes designs for four-way spectral image splitters that can take the signal from a sample containing 4 (or more) fluorophores and simultaneously project them into 4 different regions of a rectangular camera chip. Combined with notch filters, this approach can permit simultaneous imaging of all 4 labels in a single camera frame. The design is highly flexible and overcomes several limitations of earlier designs including cropping and bilateral aberrations of the spectrally resolved images (at opposite sides which reduces the usable field-of-view) owing to the aperture of filters and the lens in front of the camera, correction for rotation of the image, and the use of a reduced number of costly dichroic filters, and reduction in spectral distortion. These designs are versatile yet simple, and have minimal aberration compared to prior 2-way image splitter designs.

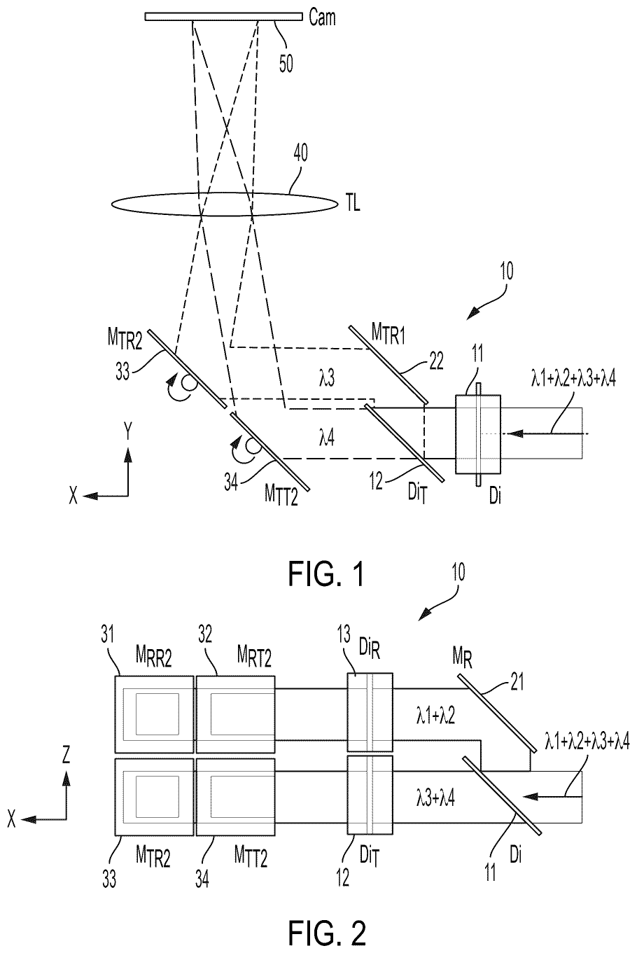

FIGS. 1, 2, and 3 are side, top-down, and mixed-perspective views, respectively, of one embodiment of a four-way image splitter 10 that can advantageously be used to capture multiple wavelength-separated images in parallel. In the FIGS. 1-3 embodiment, a first dichroic beam splitter 11 is positioned to accept an incoming beam that includes at least four wavelengths of light λ1, λ2, λ3, and λ4. The source of the incoming beam can be, for example, a light sheet microscope like the one described in U.S. Pat. No. 10,061,111, which is incorporated herein by reference. In FIGS. 1-3, the incoming beam is traveling to the left (i.e., in the X direction) when it arrives at the first dichroic beam splitter 11.

In some embodiments, λ2 is longer than λ1, λ3 is longer than λ2, and λ4 is longer than λ3, and we shall assume this relationship between the various wavelengths (i.e., λ4>λ3>λ2>λ1) in the description below for purposes of explaining the operation of the various components.

The first dichroic beam splitter 11 reflects the shorter wavelengths λ1 and λ2 onto a first optical path that proceeds in the Z direction, and transmits the longer wavelengths λ3 and λ4 onto a second optical path that proceeds in the X direction. The first optical path proceeds in the Z direction from the first dichroic beam splitter 11 until it reaches the first corner mirror 21, and subsequently proceeds in an X direction from the first corner mirror until it reaches a third dichroic beam splitter 13. The second optical path proceeds in the X direction from the first dichroic beam splitter 11 until it reaches a second dichroic beam splitter 12.

Note that the perspective in the FIG. 3 view changes between the right and left portions of the figure. More specifically, the right-most side of the figure (including the incoming beam, the first path, and the first dichroic beam splitter 11 is a top-down view, and the rest of the figure is a perspective view. Note also that the use of the nomenclature X, Y, and Z herein to denote directions does not require those directions to be horizontal or vertical with respect to the planet earth. Instead, those directions denote three mutually perpendicular directions from a very local perspective.

The second dichroic beam splitter 12 is positioned to accept light that arrives via the second optical path. The second dichroic beam splitter reflects the shorter wavelength λ3 onto a third optical path that proceeds in the Y direction, and transmits the wavelength λ4 onto a fourth optical path that proceeds in the X direction.

The third dichroic beam splitter 13 is positioned to accept light that arrives via the first optical path. The third dichroic beam splitter reflects the shorter wavelength λ1 onto a fifth optical path that proceeds in the Y direction, and transmits the longer wavelength λ2 onto a sixth optical path that proceeds in the X direction.

Two suitable sets of part numbers for the first, second, and third dichroic beam splitters 11-13 that were tested are listed below in Table 3. But other cutoff frequencies for these beam splitters can be selected to match the particular fluorophores being used.

TABLE 3

| | Semrock part number | | |
|---|---|---|---|
| | first dichroic | second dichroic | third dichroic |
| | BS 11 | BS 12 | BS 13 |
| tested system 1 | Di01-FF649 | Di01-FF699 | Di03-R594 |
| tested system 2 | Di02-FF662 | Di03-R785 | Di03-R594 |

The third optical path proceeds in a Y direction from the second dichroic beam splitter 12 to a second corner mirror 22, and subsequently proceeds in the X direction from the second corner mirror to a third steering mirror 33. The fourth optical path proceeds in the X direction from the second dichroic beam splitter 12 to a fourth steering mirror 34. The fifth optical path proceeds in the Y direction from the third dichroic beam splitter 13 to a third corner mirror 23, and subsequently proceeds in the X direction from the third corner mirror to a first steering mirror 31. And the sixth optical path proceeds in the X direction from the third dichroic beam splitter 13 to a second steering mirror 32. The second and third corner mirrors 22, 23 are preferably mounted at 45°, and are preferably mounted carefully to project as low as possible.

The steering mirrors 31-34 are positioned to redirect at least one of the third optical path, the fourth optical path, the fifth optical path, and the sixth optical path towards a camera chip 50. In the embodiment depicted in FIGS. 1-3, the steering mirrors 31-34 are positioned to redirect the third optical path, the fourth optical path, the fifth optical path, and the sixth optical path towards respective different regions of a single camera chip 50. More specifically, the first steering mirror 31 is positioned to redirect the fifth optical path (λ1—dotted line in FIG. 3) towards a first region of the camera chip 50, a second steering mirror 32 is positioned to redirect the sixth optical path (λ2-dot/dash line in FIG. 3) towards a second region of the same camera chip, a third steering mirror 33 is positioned to redirect the third optical path (λ3-short dash line in FIG. 3) towards a third region of the same camera chip, and a fourth steering mirror 34 is positioned to redirect the fourth optical path (λ4-long dash line in FIG. 3) towards a fourth region of the same camera chip. The steering mirrors 31-34 can either be end-user adjustable to fine-tune the position of each different wavelength image on the respective region of the camera chip 50, or precisely aligned in the factory.

In the embodiment depicted in FIG. 3, the first region of the camera chip is offset in the Z direction with respect to the third region of the camera chip, and the second region of the camera chip is offset in the Z direction with respect to the fourth region of the camera chip.

A lens 40 is positioned between (a) the camera chip 50 and (b) the first, second, third, and fourth steering mirrors 31-34. This lens is configured to focus light that arrives from the first, second, third, and fourth steering mirrors 31-34 onto the camera chip 50. Note that while FIG. 3 depicts a single camera chip 50 that includes four distinct regions, in alternative embodiments (not shown) a separate camera chip could be used for each of the wavelengths respectively.

In some embodiments, the center of the fifth optical path passes through an optical center of the lens 40, a center of the sixth optical path passes through the optical center of the lens, a center of the third optical path passes through the optical center of the lens, and a center of the fifth optical path passes through the optical center of the lens.

In some embodiments, a tube lens is used as the lens 40. Notably, the FIGS. 1-3 embodiment can direct spectrally-resolved beams through the center of the tube lens to mitigate aberrations. The specifications for the tube lens are chosen based on the desired magnification and camera chip physical dimensions. Considerations for selecting the tube lens include the following:

$$\frac{d}{f} = tan ( α ) , \qquad Formula$$

where f is the focal length, d is the displacement on the sensor, and α is the incident angle.

Wider apertures for the tube lens 40 are preferable, so the inventors tested the system with both a Navitar f0.95 (DO-5095) tube lens and a 50 mm Mitakon Zhongyi f0.95 tube lens. Both provided good results, but with the latter being more aberrated. These lenses were tested using both an Andor Zyla 4.2+camera (sensor size: 13.3 mm×13.3 mm), and a HiCAM Fluo camera (sensor size: 12.78 mm×12.68 mm) as the camera 50.

Note that apertures/vignetting occurs as the distance between the source and the first dichroic beam splitter 11 increases, so that distance should preferably be minimized to the extent possible. Because the image beam diverges, it may not be possible to fit the imaging beam through a 25 mm or 35 mm lens even with f1.0. On the other hand, tube lenses with longer focal lengths do not typically come with full f1.0 apertures. Hence, 50 mm tube lenses are believed to be optimal.

The FIGS. 1-3 embodiment has the following advantages over previous image splitter designs: the image paths cross at the center of the tube lens (i.e., more convergent paths); Free-space & no apertures cropping of the images; and there is no redundant second dichroic (and imprecise angle through second dichroic). In contrast, in the prior art designs, a divergent beam is cropped through the apertures, the longer wavelengths beams arrive at a different portion of the tube lens as compared to the shorter wavelength beams; and the longer path results in more divergence and vignetting.

The steering mirrors 31-34 project separated channels at an angle onto the lens 40 which can be, for example, a tube lens. This leads to separated images on the camera chip (offset δ=ƒ_{TL}*tan(α)) dependent on tubelens ƒ_{TL} and angle (α). Preferably, the steering mirrors 31-34 are as close as possible to each other. In some preferred embodiments, the steering mirrors 31-34 are adjustable in two axes (for angle offset in x and y on the camera chip 50).

The first corner mirror 21 is an important component in the FIGS. 1-3 embodiment because it reorients the first optical path so that it projects in parallel to the second optical path. This helps to keep all four images that eventually arrive at the steering mirror array 31-34 as close to the center as possible, to avoid large throws. It also introduces the angle for offsetting the first region of the camera chip 50 in the Z direction with respect to the third region of the camera chip, and offsetting the second region of the camera chip in the Z direction with respect to the fourth region of the camera chip. This results in the four different regions of the single camera chip being arranged in a 2×2 configuration onto four quadrants of the camera chip 50. Note also that the first corner mirror 21 rotates the image. But this rotation is compensated for by counter-adjusting the two steering mirrors M_{RR2} and M_{RT2} 31, 32. Finally, it can be beneficial not to mount the first corner mirror 21 at exactly 45°, but instead to deviate the mounting angle from true 45° by a small amount.

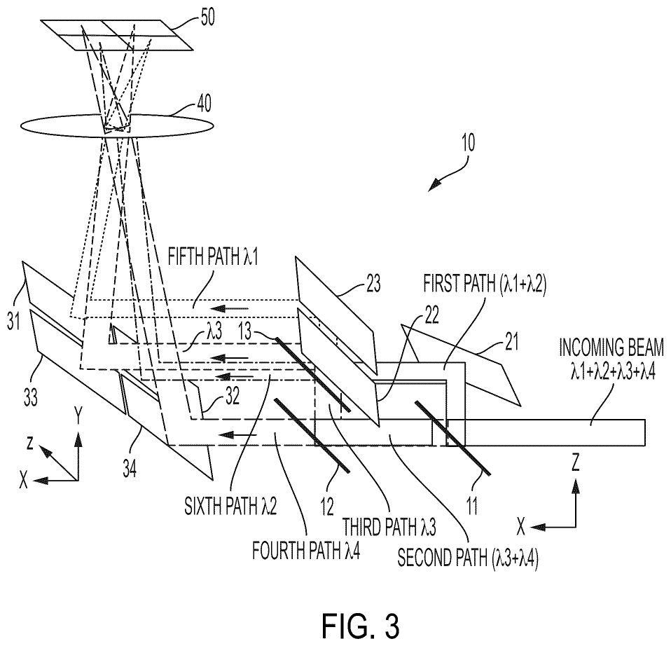

FIG. 4 depicts another embodiment of a four-way image splitter 10 that provides advantages that are similar to those described above in connection with FIGS. 1-3. In this FIG. 4 embodiment, a first dichroic beam splitter 111 is positioned to accept an incoming beam that includes at least four wavelengths of light λ1, λ2, λ3, and λ4. The source of the incoming beam can be the same as described above in connection with FIGS. 1-3. In FIG. 4, the incoming beam is traveling to the left (i.e., in the X direction) when it arrives at the first dichroic beam splitter 111.

In some embodiments, λ2 is longer than λ1, λ3 is longer than λ2, and λ4 is longer than λ3, and we shall assume this relationship between the various wavelengths (i.e., λ4>λ3>λ2>λ1) in the description below for purposes of explaining the operation of the various components.

The first dichroic beam splitter 111 reflects the shorter wavelengths λ1 and λ2 onto a first optical path that proceeds in the Y direction, and transmits the longer wavelengths λ3 and λ4 onto a second optical path that proceeds in the X direction.

The second dichroic beam splitter 112 is positioned to accept the light that arrives via the second optical path. The second dichroic beam splitter reflects the shorter wavelength λ3 onto a third optical path that proceeds in the Y direction, and transmits the longer wavelength λ4 onto a fourth optical path that proceeds in the X direction.

The third dichroic beam splitter 113 is positioned to accept the light that arrives via the first optical path. The third dichroic beam splitter reflects the shorter wavelength λ1 onto a fifth optical path that proceeds in the X direction, and transmits the longer wavelength λ2 onto a sixth optical path that proceeds in the Y direction.

The same part numbers for the first, second, and third dichroic beam splitters 11-13 described above in Table 3 in connection with the FIGS. 1-3 embodiment can be used in this FIG. 4 embodiment.

The third optical path proceeds in a Y direction from the second dichroic beam splitter 112 to a first corner mirror 121, and subsequently proceeds in an X direction from the first corner mirror to the third steering mirror 133. The fourth optical path proceeds in the X direction from the second dichroic beam splitter 112 to a fourth steering mirror 134. The fifth optical path proceeds in the X direction from the third dichroic beam splitter 113 to the first steering mirror 131. And the sixth optical path proceeds in the Y direction from the third dichroic beam splitter 113 to a second corner mirror 1λ2, and subsequently proceeds in the X direction from the second corner mirror to the second steering mirror 132. The X direction and the Y direction are perpendicular.

The steering mirrors 131-134 are positioned to redirect at least one of the third optical path, the fourth optical path, the fifth optical path, and the sixth optical path towards a camera chip 150. In the embodiment depicted in FIG. 4, the first steering mirror 131 is positioned to redirect the fifth optical path (λ1—dotted line) towards a first region of the camera chip, the second steering mirror 132 is positioned to redirect the sixth optical path (λ2-dot/dash line) towards a second region of the camera chip, the third steering mirror 133 is positioned to redirect the third optical path (λ3-short dash line) towards a third region of the camera chip, and the fourth steering mirror 134 is positioned to redirect the fourth optical path (λ4-long dash line) towards a fourth region of the camera chip. The steering mirrors 131-134 can either be end-user adjustable to fine-tune the position of each different wavelength image on the respective region of the camera chip 150, or precisely aligned in the factory.

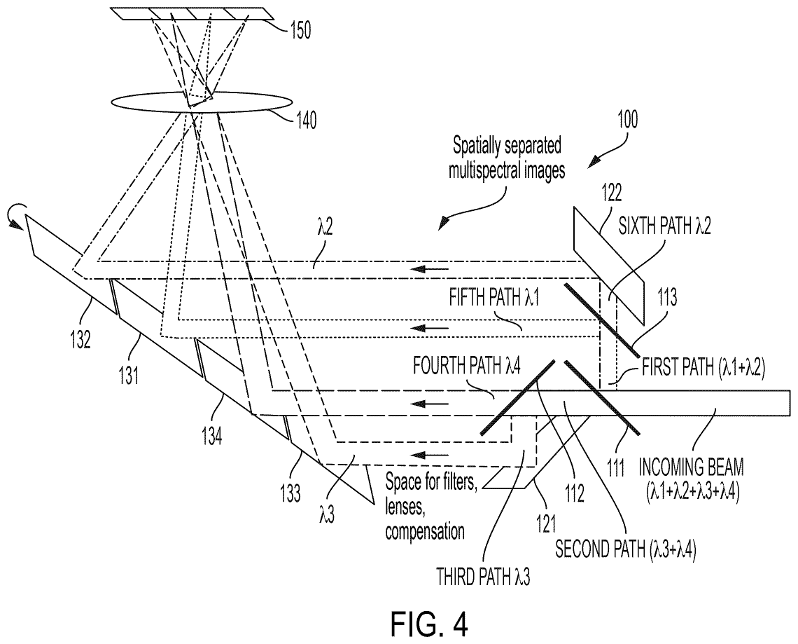

A lens 40 is positioned between (α) the camera chip 150 and (b) the first, second, third, and fourth steering mirrors 131-134. This lens 40 is configured to focus light that arrives from the first, second, third, and fourth steering mirrors 131-134 onto the camera chip 150. When all four regions are imaged using a single camera chip 150 (as depicted in FIG. 4), those four regions will be arranged side by side on the single camera chip (i.e., in a 1×4 configuration). And notably, orienting the camera chip 150 so that each of the four regions occupies a respective different set of columns within the same set of rows on the chip as depicted in FIG. 5 will provide a speed advantage. For in this orientation, it will only be necessary to read the data out of a reduced number of rows (i.e., the rows between the dashed horizontal lines in FIG. 5). It therefore follows that higher overall acquisition rates can be achieved (as compared to arranging the regions in a 2×2 configuration as described above in the FIGS. 1-3 embodiment). In alternative embodiments (not shown) the camera chip can be oriented in the other direction, or a separate camera chip can be used for each of the wavelengths respectively.

In some embodiments, the center of the fifth optical path passes through an optical center of the lens 140, the center of the sixth optical path passes through the optical center of the lens, the center of the third optical path passes through the optical center of the lens, and the center of the fifth optical path passes through the optical center of the lens. The lenses 140 and cameras 150 in this FIG. 4 embodiment can be similar to those described above in the FIG. 1-3 embodiment. Alternatively, cameras with wider sensors like the Teledyne Kinetix can be used.

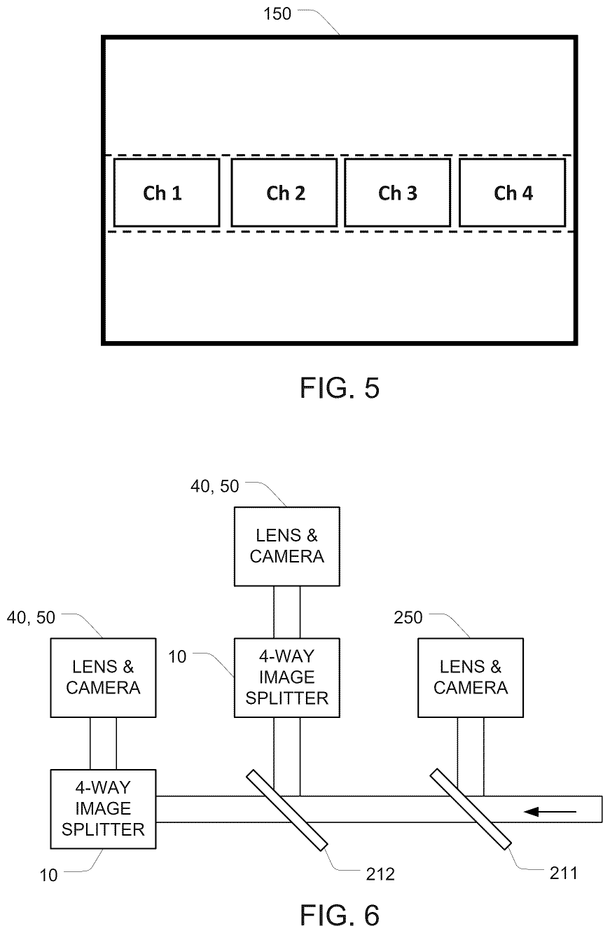

FIG. 6 depicts how multiple copies of the image splitter 50 (or 150) described above in connection with FIGS. 1-3 (or FIG. 4) can be combined into a single system. More specifically, assume that a sample can be stained with nine different fluorophores, and that light at nine different wavelengths arrives from the sample (traveling from right to left). A first long pass dichroic filter 211 reflects the shortest wavelengths towards a lens/camera combination 250 (which is used, e.g., for imaging nuclei), and transmits the eight longer wavelengths to the left. A second long pass dichroic filter 212 transmits the four longest wavelengths to the four-way image splitter 10 (on the left), and reflects the remaining four wavelengths to the other four-way image splitter 10 (in the middle). Each of these image splitters 10 splits its respective four-wavelength signal into four separate images that are ultimately imaged via respective lenses 40 onto four separate regions of the respective camera 50 (e.g. as described above in connection with FIGS. 1-3). And notably, all nine wavelengths in this embodiment can be imaged in parallel simultaneously, which can provide a tremendous speed advantage.

Finally, although the discussion of FIGS. 1-4 above has assumed that 24>13>22>21 for purposes of explaining the operation of the various components, that relationship is not mandatory. To the contrary, alternative relationships between the various wavelengths can be accommodated, as long as appropriate modifications to the passbands of the various dichroic beam splitters 11-13 (or 111-113) are made to accommodate the alternative relationships. For example, if λ1>λ2>λ3>λ4, an architecture that is similar to the ones described above in connection with FIGS. 1-3 and 4 can be used, provided that all of the long-pass dichroic beam splitters are replaced with short-pass dichroic beam splitters.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A four-way image splitter comprising:
a first dichroic beam splitter positioned to accept an incoming beam that includes four wavelengths of light λ1, λ2, λ3, and λ4, route wavelengths λ1 and λ2 onto a first optical path, and route wavelengths λ3 and λ4 onto a second optical path;
a second dichroic beam splitter positioned to accept light that arrives via the second optical path, route wavelength λ3 onto a third optical path, and route wavelength λ4 onto a fourth optical path;
a third dichroic beam splitter positioned to accept light that arrives via the first optical path, route wavelength λ1 onto a fifth optical path, and route wavelength λ2 onto a sixth optical path; and
at least one steering mirror positioned to redirect at least one of the third optical path, the fourth optical path, the fifth optical path, and the sixth optical path towards a camera chip.

2. The image splitter of claim 1, wherein λ2 is longer than λ1, wherein λ3 is longer than λ2, and wherein λ4 is longer than λ3.

3. The image splitter of claim 1, wherein the first dichroic beam splitter reflects wavelengths λ1 and λ2 onto the first optical path, and transmits wavelengths λ3 and 24 onto the second optical path.

4. The image splitter of claim 1, wherein the at least one steering mirror is positioned to redirect the third optical path, the fourth optical path, the fifth optical path, and the sixth optical path towards respective different regions of a single camera chip.

5. The image splitter of claim 1, wherein the at least one steering mirror is positioned to redirect at least three of the third optical path, the fourth optical path, the fifth optical path, and the sixth optical path towards respective different regions of a single camera chip.

6. The image splitter of claim 1, wherein the at least one steering mirror comprises a first steering mirror positioned to redirect the fifth optical path towards a first region of the camera chip, a second steering mirror positioned to redirect the sixth optical path towards a second region of the camera chip, a third steering mirror positioned to redirect the third optical path towards a third region of the camera chip, and a fourth steering mirror positioned to redirect the fourth optical path towards a fourth region of the camera chip.

7. The image splitter of claim 6, further comprising:
the camera chip; and
a lens positioned between (a) the camera chip and (b) the first, second, third, and fourth steering mirrors, wherein the lens is configured to focus light that arrives from the first, second, third, and fourth steering mirrors onto the camera chip,
wherein the first region of the camera chip, the second region of the camera chip, the third region of the camera chip, and the fourth region of the camera chip are respective different regions of a single camera chip.

8. The image splitter of claim 7, wherein a center of the fifth optical path passes through an optical center of the lens,
wherein a center of the sixth optical path passes through the optical center of the lens,
wherein a center of the third optical path passes through the optical center of the lens, and
wherein a center of the fifth optical path passes through the optical center of the lens.

9. The image splitter of claim 1, further comprising:
a first corner mirror,
wherein the first optical path proceeds in a Z direction from the first dichroic beam splitter to the first corner mirror, and subsequently proceeds in an X direction from the first corner mirror to the third dichroic beam splitter,
wherein the second optical path proceeds in the X direction from the first dichroic beam splitter to the second dichroic beam splitter, and
wherein the X direction and the Z direction are perpendicular.

10. The image splitter of claim 9, further comprising:
a second corner mirror; and
a third corner mirror,
wherein the at least one steering mirror comprises a first steering mirror positioned to redirect the fifth optical path towards a first region of the camera chip, a second steering mirror positioned to redirect the sixth optical path towards a second region of the camera chip, a third steering mirror positioned to redirect the third optical path towards a third region of the camera chip, and a fourth steering mirror positioned to redirect the fourth optical path towards a fourth region of the camera chip, wherein the third optical path proceeds in a Y direction from the second dichroic beam splitter to the second corner mirror, and subsequently proceeds in the X direction from the second corner mirror to the third steering mirror,
wherein the fourth optical path proceeds in the X direction from the second dichroic beam splitter to the fourth steering mirror,
wherein the fifth optical path proceeds in the Y direction from the third dichroic beam splitter to the third corner mirror, and subsequently proceeds in the X direction from the third corner mirror to the first steering mirror,
wherein the sixth optical path proceeds in the X direction from the third dichroic beam splitter to the second steering mirror, and
wherein the X direction, the Y direction, and the Z direction are mutually perpendicular.

11. The image splitter of claim 10, further comprising:
the camera chip; and
a lens positioned between (a) the camera chip and (b) the first, second, third, and fourth steering mirrors, wherein the lens is configured to focus light that arrives from the first, second, third, and fourth steering mirrors onto the camera chip, and
wherein the first region of the camera chip, the second region of the camera chip, the third region of the camera chip, and the fourth region of the camera chip are respective different regions of a single camera chip,
wherein the first region of the camera chip is offset in the Z direction with respect to the third region of the camera chip, and
wherein the second region of the camera chip is offset in the Z direction with respect to the fourth region of the camera chip.

12. The image splitter of claim 11, wherein a center of the fifth optical path passes through an optical center of the lens,
wherein a center of the sixth optical path passes through the optical center of the lens,
wherein a center of the third optical path passes through the optical center of the lens, and
wherein a center of the fifth optical path passes through the optical center of the lens.

13. The image splitter of claim 1, further comprising:
a first corner mirror; and
a second corner mirror,
wherein the at least one steering mirror comprises a first steering mirror positioned to redirect the fifth optical path towards a first region of the camera chip, a second steering mirror positioned to redirect the sixth optical path towards a second region of the camera chip, a third steering mirror positioned to redirect the third optical path towards a third region of the camera chip, and a fourth steering mirror positioned to redirect the fourth optical path towards a fourth region of the camera chip, wherein the third optical path proceeds in a Y direction from the second dichroic beam splitter to the first corner mirror, and subsequently proceeds in an X direction from the first corner mirror to the third steering mirror,
wherein the fourth optical path proceeds in the X direction from the second dichroic beam splitter to the fourth steering mirror,
wherein the fifth optical path proceeds in the X direction from the third dichroic beam splitter to the first steering mirror,
wherein the sixth optical path proceeds in the Y direction from the third dichroic beam splitter to the second corner mirror, and subsequently proceeds in the X direction from the second corner mirror to the second steering mirror, and
wherein the X direction and the Y direction are perpendicular.

14. The image splitter of claim 13, further comprising:
the camera chip; and
a lens positioned between (a) the camera chip and (b) the first, second, third, and fourth steering mirrors, wherein the lens is configured to focus light that arrives from the first, second, third, and fourth steering mirrors onto the camera chip,
wherein the first region of the camera chip, the second region of the camera chip, the third region of the camera chip, and the fourth region of the camera chip are respective different regions of a single camera chip, and
wherein the first, second, third, and fourth regions of the single camera chip are all arranged side by side on the single camera chip.

15. The image splitter of claim 14, wherein the first, second, third, and fourth regions of the single camera chip each occupy respective different sets of columns within a given set of rows of the single camera chip.

16. The image splitter of claim 14, wherein a center of the fifth optical path passes through an optical center of the lens,
wherein a center of the sixth optical path passes through the optical center of the lens, wherein a center of the third optical path passes through the optical center of the lens, and
wherein a center of the fifth optical path passes through the optical center of the lens.

17. A method of splitting an incoming beam that includes four wavelengths of light λ1, λ2, λ3, and λ4, the method comprising:
routing wavelengths λ1 and λ2 from the incoming beam onto a first optical path, and routing wavelengths λ3 and λ4 from the incoming beam onto a second optical path;
routing wavelength λ3 from the second optical path onto a third optical path, and routing wavelength λ4 from the second optical path onto a fourth optical path;
routing wavelength λ1 from the first optical path onto a fifth optical path, and routing wavelength λ2 from the first optical path onto a sixth optical path; and
redirecting the third optical path, the fourth optical path, the fifth optical path, and the sixth optical path towards respective different regions of a single camera chip.

18. The method of claim 17, wherein λ2 is longer than λ1, wherein λ3 is longer than λ2, and wherein λ4 is longer than λ3.

19. The method of claim 17, wherein the respective different regions of the single camera chip are arranged in a 2×2 configuration.

20. The method of claim 17, wherein the respective different regions of the single camera chip are arranged in a 1×4 configuration.
